(19) United States
(12) Patent Application Publication
(10) Pub. No.: US 2022/0040837 A1
(43) Pub. Date: Feb. 10, 2022

(54) Multi-Functional Safe-Touching Tool

(71) Applicant: Zachary Hunkins, Los Angeles, CA (US)

(72) Inventor: Zachary Hunkins, Los Angeles, CA (US)

(21) Appl. No.: 16/989,673

(22) Filed: Aug. 10, 2020

Related U.S. Application Data
(63) Continuation-in-part of application No. 29/745,753, filed on Aug. 7, 2020.

(51) Int. Cl. B25F 1/00; B26B 11/00; B67B 7/16; G06F 3/041

(52) U.S. Cl. CPC B25F 1/00; B26B 11/00; B26B 3/08; G06F 3/0416; B67B 7/16

(57) ABSTRACT

A multi-functional safe-touching tool allows a user to safely interact with door handles, touchscreen devices, or other objects. The multi-functional safe-touching tool includes a main shaft, a stylus, a door-handle claw, a bottle opener, and a user handle. The main shaft is an extension from a user's hand in order for the user to safely interact with objects. The stylus allows the multi-functional safe-touching tool to interact with a touchscreen interface. The door-handle claw allows the multi-functional safe-touching tool to engage a door handle in order to open the associated door. The bottle opener allows the multi-functional safe-touching tool to be used to open bottles. The user handle allows a user to efficiently grip the multi-functional safe-touching tool and provides leverage when opening doors using the multi-functional safe-touching tool.

The current application is a continuation-in-part (CIP) application of the U.S. non-provisional design application Ser. No. 29/745,753 filed on Aug. 7, 2020.

### FIELD OF THE INVENTION

The present invention relates generally to portable tools and devices. More specifically, the present invention is a multi-functional safe-touching tool that allows a user to safely interact with door handles, touchscreen devices, or other objects.

### BACKGROUND OF THE INVENTION

Viruses and bacterial infections can be contracted through various methods that include repetitive and common actions. These repetitive and common actions include simple actions such as opening a door or using a public touchscreen device (bank automated teller machines, retail point-of-sale systems). Many individuals contact door handles and public touchscreen devices and may not be aware that these objects may contain viral or bacterial microorganisms. There is a need for a tool that allows a user to safely perform actions such as opening a door and/or interacting with a touchscreen device.

It is therefore an objective of the present invention to provide a multi-functional safe-touching tool that allows a user to safely interact with door handles, touchscreen devices, or other objects. The present invention includes a stylus that allows the present invention to interact with touchscreen devices. The present invention also includes a door-handle claw that allows a user to engage a door-handle in order to open or close a door. Another objective of the present invention is to provide a means to open bottles. Therefore, the present invention includes a bottle opener. Another objective of the present invention is to prevent the transfer of viral or bacterial microorganisms. Therefore, the present invention includes a material composition that provides antimicrobial properties.

### BRIEF DESCRIPTION OF THE DRAWINGS

FIG. 1 is a left perspective view of the present invention.

FIG. 2 is a right perspective view of the present invention.

FIG. 3 is a front view of the present invention.

FIG. 4 is a rear view of the present invention.

FIG. 5 is an exploded front perspective view of the present invention.

### DETAIL DESCRIPTIONS OF THE INVENTION

All illustrations of the drawings are for the purpose of describing selected versions of the present invention and are not intended to limit the scope of the present invention.

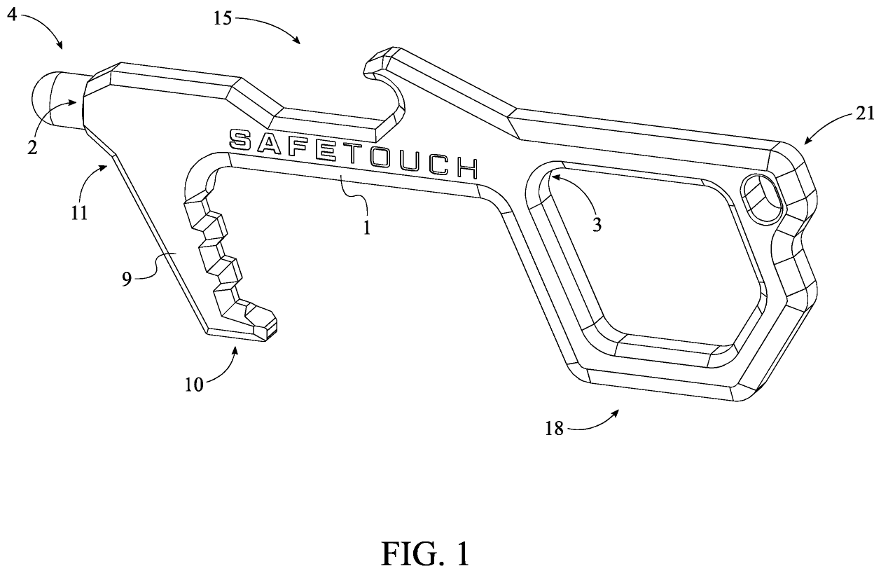

In reference to FIGS. 1 through 5, the present invention is a multi-functional safe-touching tool that allows a user to safely interact with door handles, touchscreen devices, or other objects. The present invention comprises a main shaft 1, a stylus 4, a door-handle claw 9, a bottle opener 15, and a user handle 18. The main shaft 1 is an extension from a user's hand in order for the user to safely interact with objects. The stylus 4 allows the present invention to interact with a touchscreen interface. The door-handle claw 9 allows the present invention to engage a door handle in order to open the associated door. The bottle opener 15 allows the present invention to be used to open bottles. The user handle 18 allows a user to efficiently grip the present invention and provides leverage when opening doors using the present invention.

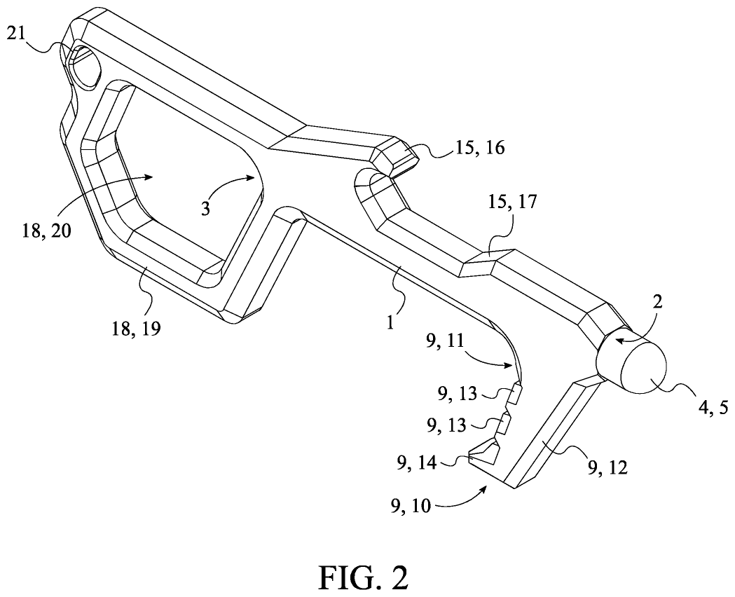

The general configuration of the aforementioned components allows a user to safely interact with objects through use of the present invention. With reference to FIG. 1, the main shaft 1 comprises a distal shaft end 2 and a proximal shaft end 3. The door-handle claw 9 comprises a fixed claw end 11 and a free claw end 10. The stylus 4 is mounted onto the distal shaft end 2. This arrangement positions the stylus 4 at the front of the main shaft 1; therefore, a user can easily interact with a touchscreen interface with the stylus 4. The user handle 18 is mounted onto the proximal shaft end 3. This arrangement positions the user handle 18 to the backend of the main shaft 1; therefore, the hand of user is separated from objects that are contacted by the front of the main shaft 1. The bottle opener 15 is laterally integrated into and along the main shaft 1. This arrangement positions the bottle opener 15 at the top lateral surface of the main shaft 1; therefore, the bottle opener 15 does not obstruct usage of the stylus 4 and the user handle 18. With reference to FIG. 2, the fixed claw end 11 is laterally connected to the elongated main body, opposite the bottle opener 15. This arrangement positions the door-handle claw 9 at the bottom lateral surface of the main shaft 1; therefore, the door-handle claw 9 is not obstructed by the bottle opener 15. Further, the fixed claw end 11 is positioned adjacent to the distal shaft end 2, and the free claw end 10 is positioned offset to the distal shaft end 2. Thus, the user can grasp a door handle at a distance with the door-handle claw 9.

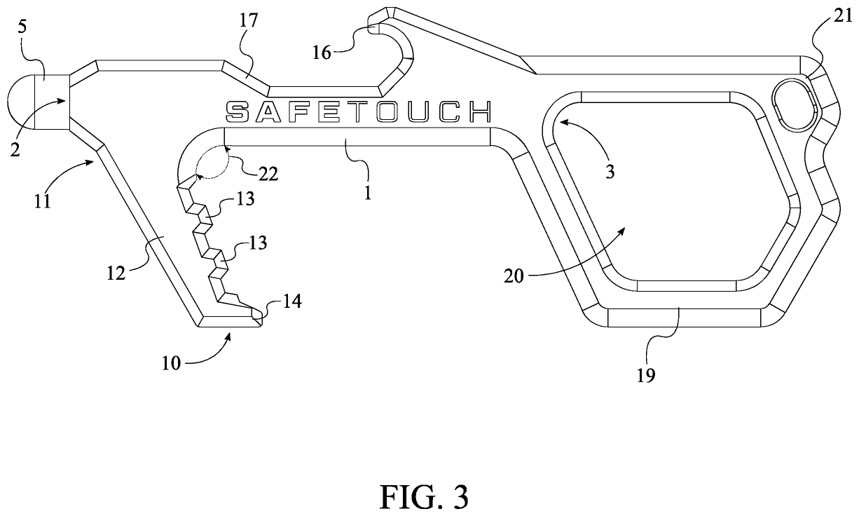

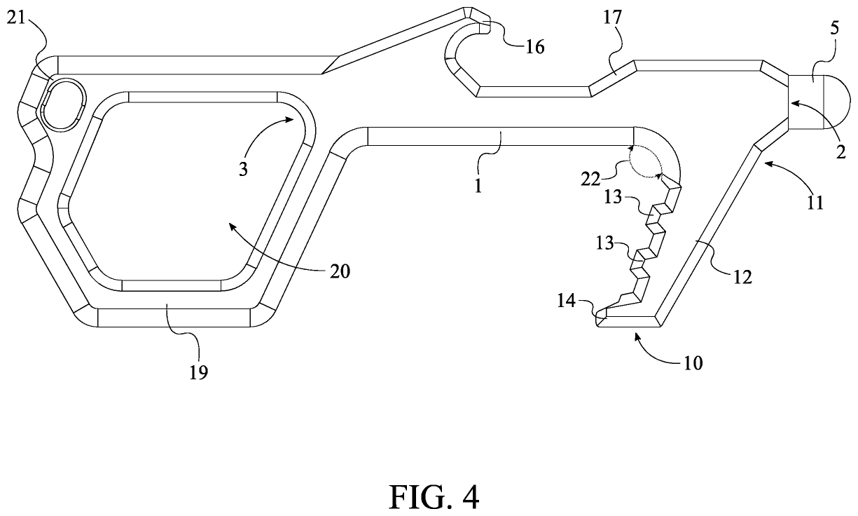

With reference to FIGS. 3 and 4, the door-handle claw 9 is angled with respect to the main shaft 1 in order to better engage to a door handle. The door-handle claw 9 comprises a claw body 12. The fixed claw end 11 and the free claw end 10 are positioned opposite to each other along the claw body 12. Thus, the claw body 12 is main part of the door-handle claw 9 that engages to a door handle. Further, the claw body 12 is oriented at an acute angle 22 with the main shaft 1. This arrangement allows the door-handle claw 9 to hook a door handle; therefore, a user can easily apply a force to turn and pull or push a door handle with the door-handle claw 9.

In order for the door-handle claw 9 to grip a door handle and with reference to FIGS. 3 and 4, the door-handle claw 9 may further comprise a plurality of gripping teeth 13. The plurality of gripping teeth 13 increases friction between the door-handle claw 9 and a door handle. The plurality of gripping teeth 13 is laterally integrated along the claw body 12. In further detail, the plurality of gripping teeth 13 may be notched into the claw body 12. The plurality of gripping teeth 13 is positioned in between the fixed claw end 11 and the free claw end 10. This arrangement positions the plurality of gripping teeth 13 in order to allow the claw body 12 to grip a door handle. Further, the plurality of gripping teeth 13 is oriented towards proximal shaft end 3. This arrangement positions the plurality of gripping teeth 13 on a specific surface of the claw body 12 in order for the door-handle claw 9 to hook and grip a door handle.

In order for the door-handle claw 9 to be used to open boxes and with reference to FIGS. 3 and 4, the door-handle claw 9 may further comprise a box-cutting feature 14. The box-cutting feature 14 is a protrusion at the end of the door-handle claw 9 that is sharp enough to dig into and pierce tape or similar package sealing material. The box-cutting feature 14 is integrated into the free claw end 10. This arrangement positions the box-cutting feature 14 in order to be easily used to pierce through package sealing material. Further, the box-cutting feature 14 is oriented towards the proximal shaft end 3. This arrangement positions the box-cutting feature 14 in order for a user to easily apply a force onto a box with the box-cutting feature 14.

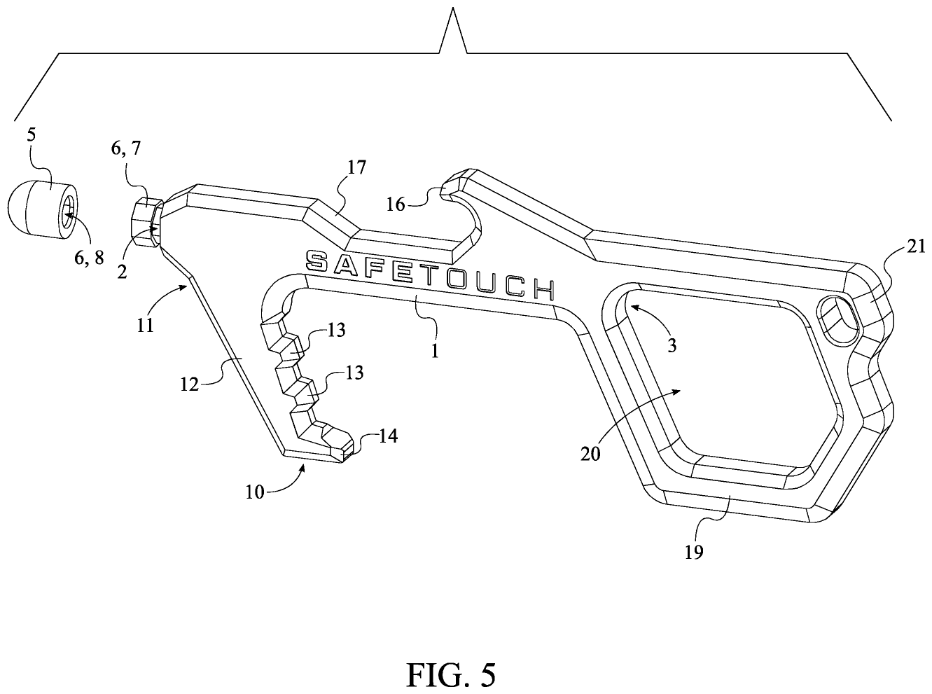

The stylus 4 can be mounted to the distal shaft end 2 through various methods. In the preferred embodiment and with reference to FIG. 5, the stylus 4 may comprise a tip body 5 and a fastener 6. The tip body 5 is the part of the stylus 4 that allows for interaction with touchscreen devices. The tip body 5 is preferably made of a rubber material. In further detail, the tip body 5 is preferably made of conductive rubber material in order to transfer a capacitance when in contact with a touchscreen device. The fastener 6 comprises a male portion 7 and a female portion 8. The male portion 7 is preferably a nut-shaped protrusion. The male portion 7 is connected onto the distal shaft end 2. In further detail, the male portion 7 is one structural piece with the main shaft 1. The female portion 8 is a cavity designed to receive the male portion 7. The female portion 8 traverses into tip body 5. Further, the female portion 8 is engaged by the male portion 7, which allows the stylus 4 to be mounted.

In order for a user to easily grip the user handle 18 and with reference to FIG. 2, the user handle 18 may comprise a handle body 19 and a finger-receiving hole 20. The handle body 19 is the solid part of the user handle 18. The finger-receiving hole 20 is a cutout designed to receive at least one finger of a user. In further detail, a user gains more leverage through finger gripping of the finger-receiving hole 20. The finger-receiving hole 20 traverses through the handle body 19 and is positioned perpendicular to the main shaft 1. This arrangement positions the finger-receiving hole 20 where it can be easily gripped by a user.

With reference to FIG. 2, the present invention may further comprise a key-ring eyelet 21 that allows the present invention to be attached to a key ring. The key-ring eyelet 21 is connected adjacent to the user handle 18, opposite to the proximal shaft end 3. This arrangement positions the key-ring eyelet 21 where the key-ring eyelet 21 does not obstruct the other components of the present invention. Further, the key-ring eyelet 21 is positioned near the user handle 18 so that a user can still use the present invention if the present invention is attached to a key ring.

In order for the bottle opener 15 to be effectively used to open bottles, the bottle opener 15 comprises a leveraging wedge 16 and a fulcrum 17. The fulcrum 17 is positioned adjacent to the distal shaft end 2. This arrangement positions the fulcrum 17 in order to allows a user to apply a sufficient force onto the fulcrum 17 to open a bottle. The leveraging wedge 16 is positioned adjacent to the proximal shaft end 3 and is oriented towards the distal shaft end 2. This arrangement positions the leveraging wedge 16 in order to allow a user to easily engage the leveraging wedge 16 underneath a bottle cap. Thus, the bottle opener 15 can effectively be used to open a bottle by grasping the user handle 18 and rotating the present invention about the fulcrum 17.

The present invention can be made of various materials. In one embodiment, the main shaft 1, the door-handle claw 9, the bottle opener 15, and the user handle 18 are made of a copper material. This material composition of the present invention provides antimicrobial properties so that bacteria cannot be transferred from the present invention. In another embodiment, the main shaft 1, the door-handle claw 9, the bottle opener 15, and the user handle 18 are made of a zinc-and-aluminum material. The zinc in this material composition for the present invention provides antimicrobial properties. The aluminum in this material composition for the present invention provides anticorrosion properties and makes the present invention robust.

Although the invention has been explained in relation to its preferred embodiment, it is to be understood that many other possible modifications and variations can be made without departing from the spirit and scope of the invention as hereinafter claimed.

What is claimed is:

1. A multi-functional safe-touching tool comprises:
a main shaft;
a stylus;
a door-handle claw;
a bottle opener;
a user handle;
the main shaft comprises a distal shaft end and a proximal shaft end;
the door-handle claw comprises a fixed claw end and a free claw end;
the stylus being mounted onto the distal shaft end;
the user handle being mounted onto the proximal shaft end;
the bottle opener being laterally integrated into and along the main shaft;
the fixed claw end being laterally connected to the elongated main body, opposite the bottle opener;
the fixed claw end being positioned adjacent to the distal shaft end; and
the free claw end being positioned offset to the distal shaft end.

2. The multi-functional safe-touching tool as claimed in claim 1 comprises:
the door-handle claw comprises a claw body;
the fixed claw end and the free claw end being positioned opposite of each other along the claw body; and
the claw body being oriented at an acute angle with the main shaft.

3. The multi-functional safe-touching tool as claimed in claim 1 comprises:
the door-handle claw comprises a claw body and a plurality of gripping teeth;
the fixed claw end and the free claw end being positioned opposite of each other along the claw body;
the plurality of gripping teeth being laterally integrated along the claw body;
the plurality of gripping teeth being positioned in between the fixed claw end and the free claw end; and
the plurality of gripping teeth being oriented towards the proximal shaft end.

4. The multi-functional safe-touching tool as claimed in claim 1 comprises:
the door-handle claw comprises a box-cutting feature;
the box-cutting feature being integrated into the free-claw end; and
the box-cutting feature being oriented towards the proximal shaft end.

5. The multi-functional safe-touching tool as claimed in claim 1 comprises:
the stylus comprises a tip body and a fastener;
the fastener comprises a male portion and a female portion;
the male portion being connected onto the distal shaft end;
the female portion traversing into the tip body; and
the female portion being engaged by the male portion.

6. The multi-functional safe-touching tool as claimed in claim 5 comprises:
the tip body being made of a rubber material.

7. The multi-functional safe-touching tool as claimed in claim 1 comprises:
the user handle comprises a handle body and a finger-receiving hole;
the finger-receiving hole traversing through the handle body; and
the finger-receiving hole being positioned perpendicular to the main shaft.

8. The multi-functional safe-touching tool as claimed in claim 1 comprises:
a key-ring eyelet; and
the key-ring eyelet being connected adjacent to the user handle, opposite to the proximal shaft end.

9. The multi-functional safe-touching tool as claimed in claim 1 comprises:
the bottle opener comprises a leveraging wedge and a fulcrum;
the fulcrum being positioned adjacent to the distal shaft end;
the leveraging wedge being positioned adjacent to the proximal shaft end; and
the leveraging wedge being oriented towards the distal shaft end.

10. The multi-functional safe-touching tool as claimed in claim 1 comprises:
the main shaft, the door-handle claw, the bottle opener, and the user handle being made of a copper material.

11. The multi-functional safe-touching tool as claimed in claim 1 comprises:
the main shaft, the door-handle claw, the bottle opener, and the user handle being made of a zinc-and-aluminum material.

12. A multi-functional safe-touching tool comprises:
a main shaft;
a stylus;
a door-handle claw;
a bottle opener;
a user handle;
the main shaft comprises a distal shaft end and a proximal shaft end;
the door-handle claw comprises a fixed claw end, a free claw end, a claw body, and a plurality of gripping teeth;
the fixed claw end and the free claw end being positioned opposite of each other along the claw body;
the plurality of gripping teeth being laterally integrated along the claw body;
the plurality of gripping teeth being positioned in between the fixed claw end and the free claw end; and
the plurality of gripping teeth being oriented towards the proximal shaft end.
the stylus being mounted onto the distal shaft end;
the user handle being mounted onto the proximal shaft end;
the bottle opener being laterally integrated into and along the main shaft;
the fixed claw end being laterally connected to the elongated main body, opposite the bottle opener;
the fixed claw end being positioned adjacent to the distal shaft end;
the free claw end being positioned offset to the distal shaft end;
the fixed claw end and the free claw end being positioned opposite of each other along the claw body;
the claw body being oriented at an acute angle with the main shaft;
the plurality of gripping teeth being laterally integrated along the claw body;
the plurality of gripping teeth being positioned in between the fixed claw end and the free claw end; and
the plurality of gripping teeth being oriented towards the proximal shaft end.

13. The multi-functional safe-touching tool as claimed in claim 12 comprises:
the door-handle claw comprises a box-cutting feature;
the box-cutting feature being integrated into the free-claw end; and
the box-cutting feature being oriented towards the proximal shaft end.

14. The multi-functional safe-touching tool as claimed in claim 12 comprises:
the stylus comprises a tip body and a fastener;
the fastener comprises a male portion and a female portion;
the male portion being connected onto the distal shaft end;
the female portion traversing into the tip body; and
the female portion being engaged by the male portion.

15. The multi-functional safe-touching tool as claimed in claim 14 comprises:
the tip body being made of a rubber material.

16. The multi-functional safe-touching tool as claimed in claim 12 comprises:
the user handle comprises a handle body and a finger-receiving hole;
the finger-receiving hole traversing through the handle body; and
the finger-receiving hole being positioned perpendicular to the main shaft.

17. The multi-functional safe-touching tool as claimed in claim 12 comprises:
a key-ring eyelet; and
the key-ring eyelet being connected adjacent to the user handle, opposite to the proximal shaft end.

18. The multi-functional safe-touching tool as claimed in claim 12 comprises:
the bottle opener comprises a leveraging wedge and a fulcrum;
the fulcrum being positioned adjacent to the distal shaft end;
the leveraging wedge being positioned adjacent to the proximal shaft end; and
the leveraging wedge being oriented towards the distal shaft end.

19. The multi-functional safe-touching tool as claimed in claim 12 comprises:
the main shaft, the door-handle claw, the bottle opener, and the user handle being made of a copper material.

20. The multi-functional safe-touching tool as claimed in claim 12 comprises:
the main shaft, the door-handle claw, the bottle opener, and the user handle being made of a zinc-and-aluminum material.
